(19) United States
(12) Patent Application Publication
(10) Pub. No.: US 2022/0266636 A1
(43) Pub. Date: Aug. 25, 2022

(54) PNEUMATIC TIRE

(71) Applicant: Toyo Tire Corporation, Itami-shi (JP)

(72) Inventor: Kazuo Shimomura, Itami-shi (JP)

(73) Assignee: Toyo Tire Corporation, Itami-shi (JP)

(21) Appl. No.: 17/590,908

(22) Filed: Feb. 2, 2022

(30) Foreign Application Priority Data
Feb. 25, 2021 (JP) 2021-029062

(51) Int. Cl. B60C 15/00

(52) U.S. Cl. CPC B60C 15/0045

(57) ABSTRACT

In a pneumatic tire according to an embodiment, a carcass ply includes a first ply hung between a pair of bead cores and a second ply formed of a pair of ply pieces arranged on tire outer surface sides of the first ply and respectively extending from one ends positioned on a tread to beads on both sides through sidewalls on both sides to be folded about the bead cores. One end of each ply piece is positioned on an outer side in a tire width direction than a shoulder main groove and on an inner side in the tire width direction than an outer end in a width direction of a belt.

### CROSS-REFERENCE TO RELATED APPLICATIONS

This application is based upon and claims the benefit of priority from the prior Japanese Patent Application No. 2021-029062, filed on Feb. 25, 2021; the entire contents of which are incorporated herein by reference.

### BACKGROUND

### 1. Field of the Invention

An embodiment of the present invention relates to a pneumatic tire.

### 2. Description of Related Art

There is disclosed in JP-A-2017-1.09517 a pneumatic tire including a carcass ply hung between a pair of bead cores in which the carcass ply is formed of two or more carcass plies, and the carcass ply near the belt is a hollow ply a center side of which is removed. An object of JP-A-2017-109517 is to improve cutting resistance of a buttress part having a recessed part while decreasing rolling resistance by reducing the weight in the carcass ply formed of two or more plies. In order to achieve the object, the hollow ply is arranged at a position corresponding to at least the recessed part of the buttress part, and an inner end of the hollow ply is arranged between a position corresponding to a grounding end of a tread part and a position corresponding to an inner end of a curve part of an inner liner.

### SUMMARY

As described above, in JP-A-2017-109517, the position of the end part of the hollow ply has been considered from viewpoints of the decrease in rolling resistance and the cutting resistance at the buttress part, and has not been considered from a viewpoint of enveloping characteristics. The carcass ply may harden the tread when existing in the tread as the carcass ply is a reinforcement, which may be a factor of reducing the enveloping characteristics. Accordingly, it is desirable that the position of the end part of the hollow ply is considered from the viewpoint of enveloping characteristics even when the carcass ply is formed of two or more carcass plies and the hollow ply is provided. Here, the enveloping characteristics are characteristics in which the tread is deformed to envelop a protrusion when a tire climbs over small protrusions such as a joint or a level difference on a road. When the enveloping characteristics are improved, the impact from a road surface can be absorbed to thereby improve riding comfort.

In view of the above, an object of an embodiment of the present invention is to provide a pneumatic tire capable of being reduced in weight and improving enveloping characteristics.

A pneumatic tire according to an embodiment of the present invention includes a pair of bead cores, a carcass ply containing organic fiber cords, a belt, and a tread rubber provided on an outer side in a tire radial direction of the belt. The tread rubber is provided with a pair of shoulder main grooves extending in a tire circumferential direction so as to demarcate shoulder lands from a land or an inner side thereof in a tire width direction. The carcass ply includes a first ply and a second ply. The first ply is hung between the pair of bead cores. The second ply is formed of a pair of ply pieces arranged on tire outer surface sides of the first ply and respectively extending from one ends positioned in a tread to beads on both sides through sidewalls on both sides to be folded around the bead cores. Each of the one ends of the pair of ply pieces of the second ply is positioned on an outer side in the tire width direction than the shoulder main groove and on the inner side in the tire width direction than an outer end in a width direction of the belt.

In the embodiment, the belt may include a first belt having the maximum width and a second belt arranged on the outer side in the tire radial direction of the first belt. In this case, an overlapping amount of each of the pair of ply pieces and the first belt may be 5 mm or more, and the overlapping amount may also be 5 mm or more and 50 mm or less. A protruding amount of the first belt from an outer end in the width direction of the second belt may be 4 mm or more. An overlapping amount of each of the pair of ply pieces and the second belt may be 3 mm or more.

In the pneumatic tire according to the embodiment of the invention, the first ply hung between the pair of bead cores is provided and the second ply formed of the pair of ply pieces extending from one ends positioned in the tread to both sides is provided as the carcass ply. The one end of the second ply is arranged on the outer side in the tire width direction than the shoulder main groove. Accordingly, the tire can be reduced in weight and the tread can be flexibly deformed, which can improve enveloping characteristics.

### BRIEF DESCRIPTION OF THE DRAWINGS

FIG. 1 is a cross-sectional view of a pneumatic tire according to an embodiment;

FIG. 2 is a half-cross sectional view of the pneumatic tire; and

FIG. 3 is an enlarged cross-sectional view of a relevant part of the pneumatic tire.

### DESCRIPTION OF EMBODIMENTS

Hereinafter, an embodiment of the present invention will be explained with reference to the drawings.

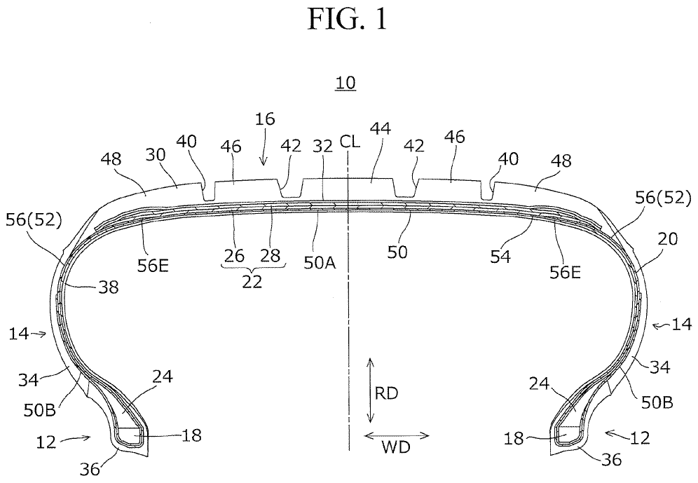

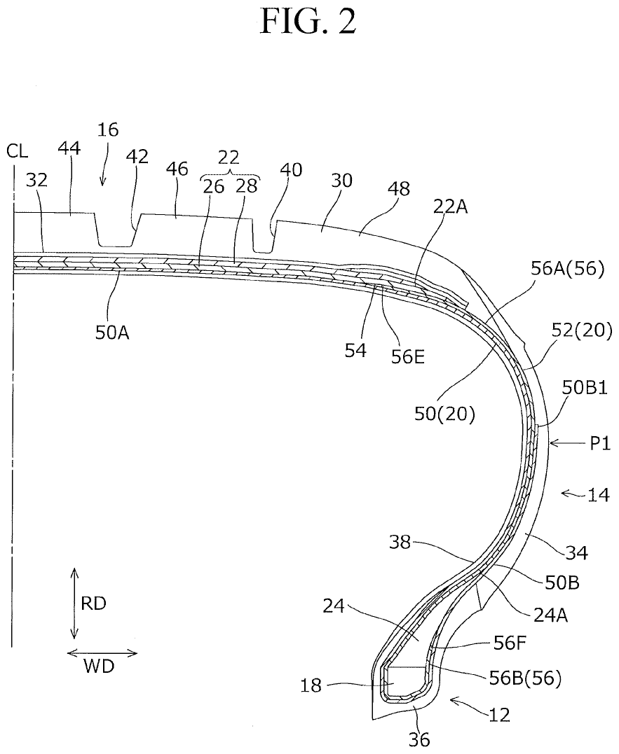

A pneumatic tire 10 (hereinafter referred to merely as tire 10) according to an embodiment shown in FIG. 1 to FIG. 3 includes a right and left pair of beads 12, 12 configured to be fixed to a rim, a right and left pair of sidewalls 14, 14 respectively extending on outer sides in a tire radial direction from the pair of beads 12, 12, and a tread 16 extending between the pair of sidewalls 14, 14 to form a grounding surface. FIG. 1 is a cross-sectional view of the tire 10 cut by a cross section at a meridian including a tire rotation axis.

In the drawings, a symbol CL represents a tire equatorial plane corresponding to the center in a tire width direction. In the specification, the tire width direction is referred to also as a tire axial direction, which represents a direction parallel to the tire rotation axis and shown by a symbol WD in the drawings. An inner side in the tire width direction WD is a direction coming close to the tire equatorial plane CL. An outer side in the tire width direction WD is a direction going apart from the tire equatorial plane CL. The tire radial direction represents a direction perpendicular to the tire rotation axis, which is shown by a symbol RD in the drawings. An inner side in the tire radial direction RD is a direction coming close to the tire rotation axis. An outer side in the tire radial direction RD is a direction going apart from the tire rotation axis. A tire circumferential direction represents a direction rotating around the tire rotation axis.

The tire 10 includes a right and left pair of bead cores 18, 18, a carcass ply 20 hung between the pair of bead cores 18, 18, and a belt 22 arranged on the outer side in the tire radial direction RD of a crown of the carcass ply 20.

The bear core 18 is an annular member formed of a steel bead wire and extending over the entire circumference of the tire circumferential direction, which is embedded in the bead 12. A bead filler 24 set in an outer circumference of the bear core 18 is also embedded in the bead 12. The bead filler 24 is an annular hard rubber member extending over the entire circumference in the tire circumferential direction with an approximately triangular shape in cross section which becomes narrower in width toward the outer side in the tire radial direction RD.

The carcass ply 20 is hung between the pair of bead cores 18, 18 in a toroidal shape. That is, the carcass ply 20 extends from the tread 16 to the beads 12, 12 on both sides through the sidewalls 14, 14 on both sides and is folded around the bead cores 18 to be locked.

The carcass ply 20 contains organic fiber cords as a reinforcement. The carcass ply 20 includes an array of the organic fiber cords and a topping rubber covering the array. The array is configured by arranging a predetermined thread count of organic fiber cords in parallel. The organic fiber cords are arranged at substantially right angles (for example, 80 to 90 degrees) with respect to the tire circumferential direction, namely, along a meridian direction. As the organic fiber cords, for example, polyester fiber, rayon fiber, aramid fiber, nylon fiber, and the like can be cited.

The belt 22 is arranged on an outer circumferential side of the crown (namely, the top) of the carcass ply 20 having the toroidal shape, which is provided to overlap with an outer circumferential surface of the carcass ply 20 in the tread 16. The belt 22 is formed of at least one belt ply, and preferably two or more belt plies.

In this example, the belt 22 is formed of two belts including a first belt 26 with the maximum width and a second belt 28 arranged on the outer side in the tire radial direction RD of the first belt 26. The first belt 26 is the maximum-width belt having the widest width. The second belt 28 is the outermost belt arranged to overlap with an outer circumference of the first belt 26, which is a narrower belt than the first belt 26.

The first belt 26 and the second belt 28 contain metal cords such as steel cords. Specifically, the first belt 26 and the second belt 28 are formed by arranging metal cords to be inclined at predetermined angles (for example, 15 to 35 degrees) with respect to the tire circumferential direction and at predetermined intervals in the tire width direction WD and covering the metal cords with the topping rubber. The metal cords are arranged to cross each other between the two belts 26, 28.

A tread rubber 30 forming the grounding surface is provided on the outer side in the tire radial direction RD of the belt 22. The tread rubber 30 may have a two-layered structure including a cap rubber layer forming the grounding surface contacting a road surface and a base rubber layer arranged in the inner side in the tire radial direction RD of the cap rubber layer, and may have a single-layer structure in which the cap rubber layer and the base rubber layer are integrally formed.

A belt reinforcing layer 32 is provided between the belt 22 and the tread rubber 30. The belt reinforcing layer 32 is formed of a cap ply containing organic fiber cords extending substantially in parallel to the tire circumferential direction.

Sidewall rubbers 34 forming tire outer surfaces are provided on a tire outer surface side of the carcass ply 20 in the sidewalls 14. Rim strip rubbers 36 forming outer surfaces of the beads 12 and contacting the rim are provided in the beads 12 so as to be adjacent to the sidewall rubbers 34. An inner liner 36 made of air impermeable rubber is provided on an inner surface of the tire 10, namely, on the tire inner surface side of the carcass ply 20.

On the grounding surface of the tread rubber 30, a right and left pair of shoulder main grooves 40, 40 extending in the tire circumferential direction, and center main grooves 42, 42 positioned on the inner side in the tire width direction WD of the shoulder main grooves 40, 40 and extending in the tire circumferential direction are provided. In this example, a right and left pair of, namely, two center main grooves 42, 42 are provided on both sides of the tire equatorial plane CL. One center main groove 42 may be provided, and no center main groove 42 may be provided. The shoulder main grooves 40 and the center main grooves 42 may be respectively extended straight or may be extended zigzag in the tire circumferential direction. A groove width (opening width) of the shoulder main groove 40 and the center main groove 42 is not particularly limited, which may be, for example, 6 mm or more as well as 20 mm or less.

On the grounding surface of the tread rubber 30, a plurality of lands are formed to be demarcated by the above main grooves. In this example, there are provided a center land 44 existing between the pair of center main grooves 42, 42, mediate lands 46, 46 existing between the center main groove 42 and the shoulder main groove 40, and shoulder lands 48, 48 existing on the outer side of the shoulder main groove 40 in the tire width direction WD.

The center land 44 is a central land in the tire width direction WD, which includes the tire equation plane CL. The mediate lands 46 are a right and left pair of lands, which are respectively provided on both sides of the center land 44 in the tire width direction WD. The shoulder lands 48 are a right and left pair of lands respectively provided on outer sides in the tire width direction WD of the right and left pair of mediate lands 46, 46, which include grounding ends. These center land 44, the mediate lands 46 and the shoulder lands 48 may be ribs which are lands continuing in the tire circumferential direction, which are not separated by lateral grooves, or may be block rows which are intermittent lands separated by lateral grooves arranged at intervals in the tire circumferential direction.

The shoulder main groove 40 is a circumferential direction groove demarcating the shoulder land 48 from the land on the inner side in the tire width direction WD. The land demarcated from the shoulder land 48 by the shoulder main groove 40 is the mediate land 46 in this example. However, when one center main groove 42 exists or no center main groove 42 exists, and no mediate land 46 exists, the land demarcated from the shoulder land 48 may be the center land 44.

In the embodiment, the carcass ply 20 includes a first ply 50 hung between the pair of bead cores 18, 18 and a second ply 52 arranged to overlap with a tire outer surface side of the first ply 50 (for example, the outer side in the tire width direction WD in the sidewalls 14).

The first ply 50 is a turn-up ply both ends of which are folded around the bead cores 18, 18. That is, the first ply 50 includes a toroidal-shaped ply body 50A extending between the pair of bead cores 18, 18 and folded portions SOB, 50B extending from the ply body 50A and folded from the inner side to the outer side in the tire width direction WD around the bead cores 18. The first ply 50 is locked by being folded at the both ends as described above. Accordingly, the bead cores 18 and the bead fillers 24 are arranged between the ply body 50A and the folded portions 50B.

The ply body 50A of the first ply 50 reaches the beads 12, 12 respectively from the tread 16 through the sidewalls 14, 14 on the both sides, extending to inner circumferential surfaces of the bead cores 18 through the inner side in the tire width direction WD of the bead fillers 24. The folded portion 50B extends from the inner circumferential surface of the bead core 18 to the outer side in the tire radial direction RD through the outer sides in the wire width direction WD of the bead fillers 24. In this example, the folded portion 50B extends across an outer side end 24A in the tire radial direction RD of the bead filler 24 and across a tire maximum width position P1, terminating before reaching an end of the belt 22. Therefore, an outer side end 50B1 in the ti re radial direction RD of the folded portion 50B is positioned on the outer side in the tire radial direction RD of the tire maximum width position P1. The position of the outer side end 50B1 of the folded portion 50B is not particularly limited, which may be, for example, the inner side in the tire radial direction RD of the tire maximum width position P1.

Here, the tire maximum width position P1 is a position where a profile line of the outer surface of the tire 10 in the sidewall 14 is furthermost from the tire equatorial plane CL toward the tire width direction WD, which is the position in the tire radial direction RD. The profile line is a contour of an outer surface of the sidewall body excluding protrusions such as a rim protector. The profile line normally has a shape of a tire meridian cross section prescribed by connecting plural arcs smoothly.

The second ply 52 is specifically formed of a right and left pair of ply pieces 56, 56 respectively extending to the beads 12, 12 on both ends from one ends 56E, 56E positioned in the tread 16 through the sidewalls 14, 14 on both ends.

The second ply 52, specifically, end portions of the pair of ply pieces 56, 56 forming the second ply 52 are folded around the bead cores 18, 18 in the beads 12, 12. In this example, the pair of ply pieces 56, 56 are folded around the bead cores 18, 18 from the inner side to the outer side in the tire width direction WD. Therefore, each ply piece 56 includes a ply body 56A and a folded portion 56B. The ply body 56A reaches the bead 12 from the one end 56E through the sidewall 14, extending to the inner circumferential surface of the bead core 18 through the inner side in the tire width direction WD of the bead filler 24. The folded portion 56B extends from the inner circumferential surface of the bead core 18, extending to the outer side in the tire radial direction RD along the outer side in the tire width direction WE) of the bead filler 24. In this example, an outer side end in the tire radial direction RD of the folded portion 56B, that is, the other end 56F of the ply piece 56 is positioned between the outer circumferential surface of the bead core 18 and the outer side end 24A in the tire radial direction RD of the bead filler 24.

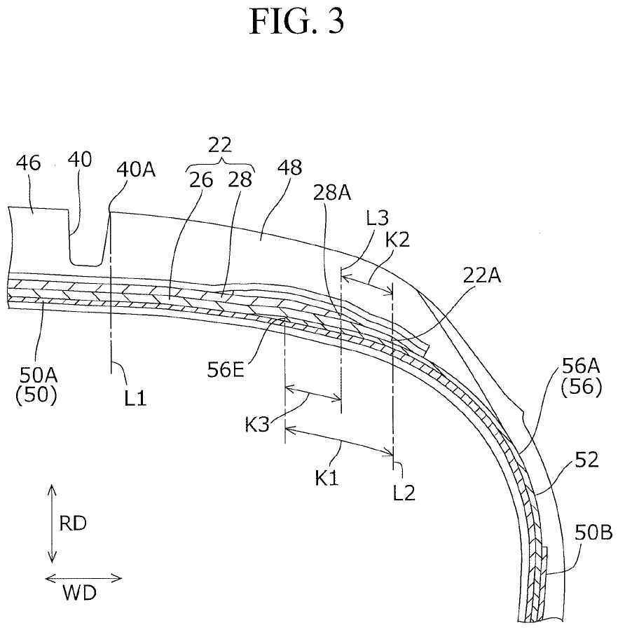

As shown in FIG. 3, the one end 56E of each ply piece 56 of the second ply 52 is positioned on the outer side in the tire width direction WD than the shoulder main groove 40 and on the inner side in the tire width direction WD than an outer end 22A in the width direction of the belt 22. That is, the one ends 56E, 56E respectively positioned at both end portions of the tread 16 are positioned on the outer side of respective corresponding shoulder main grooves 40, 40 and on the inner side of the belt ends 22A, 22A in the tire width direction WD.

Specifically, the one end 56E of each ply piece 56 is positioned on the outer side in the tire width direction WD than a straight line L1. The straight line L1 is a straight line passing through a portion 40A positioned on the outermost side in the tire width direction WI) in the shoulder main groove 40 (an opening end on the outer side in the width direction of the shoulder main groove 40 in the drawing) and parallel to the tire radial direction RD.

The one end 56E of each ply piece 56 is positioned on the inner side in the tire width direction WD than a straight line L2. The straight line L2 is a straight line passing through the outer end 22A in the width direction of the belt 22 and parallel to the tire radial direction RD. The outer end 22A in the width direction of the belt 22 is an outer end in the tire width direction WD of the first belt 26 which is the maximum width belt.

According to the embodiment, the carcass ply 20 is configured by including the first ply 50 hung between the pair of bead cores 18, 18 and the second ply 52 including the pair of ply pieces 56, 56 extending from the both end portions of the tread 16 to the sidewalls 14, 14 on both ends. Accordingly, a two-ply structure is formed in the sidewalls 14 and a one-ply structure is formed at the central part of the tread 16. The tension applied to the carcass ply is small at the central part of the tread according to tension analysis results. Accordingly, when the one-ply structure is formed at the tread central part, the tire can be reduced in weight while maintaining case rigidity due to the two-ply structure. The rolling resistance can be decreased when the tire is reduced in weight, and responsiveness is improved by reducing an unsprung load, thereby improving steering stability.

Also according to the embodiment, one end 56E of the second ply 56 is arranged on the outer side in the tire width direction WD of the shoulder main groove 40. Accordingly, the tread 16 is flexibly deformed, and enveloping characteristics can be improved. Regarding this point, the rubber in a portion where the shoulder main groove 40 is provided in the tread 16 generally becomes thin. Therefore, flexure deformation starting from the shoulder main groove 40 easily occurs and the impact occurring by protrusions such as a joint or a level difference on the road can be absorbed. However, if the second ply 52 is extended to the inner side in the tire width direction WD of the shoulder main groove 40, rigidity on a bottom side of the shoulder main groove 40 is increased. Accordingly, easiness in flexure deformation in the tread 16 starting from the shoulder main groove 40 is impaired. As the second ply 52 is provided so as not to overlap with the shoulder main groove 40 according to the embodiment, the flexure deformation in the tread 16 starting from the shoulder main groove 40 easily occurs. Therefore, enveloping characteristics with respect to unevenness of the road surface due to potholes and cracks on the road, joints on a pavement, a level difference of a manhole, an unpaved road, and the like can be improved, which can improve riding comfort and improve traveling performance on a bad road.

To arrange the one end 56E of the second ply 56 on the outer side in the tire width direction WD of the shoulder main groove 40 also leads to decrease in rolling resistance due to reduction in weight of the tire.

Also according to the embodiment, the one end 56E of each ply piece 56 in the second ply 52 is arranged on the inner side in the tire width direction WD of the outer end 22A in the width direction of the belt 22. Accordingly, the one end 56E of the ply piece 56 can be sandwiched between the belt 22 and the first ply 50 to be held. Accordingly, it is possible to restrict movement of the end portion of the ply piece 56 which generally easily moves and suppress heat generation, which leads to decrease in rolling resistance. Also, deterioration of the rubber due to heat generation can be suppressed, whereby failure can be suppressed.

In the embodiment, it is preferable that an overlapping amount K1 of each ply piece 56 of the second ply 52 and the first belt 26 is 5 mm or more. The overlapping amount K1 is preferably 5 mm or more and 50 mm or less, and more preferably 5 mm or more and 15 mm or less.

When the overlapping mount K1 is 5 mm or more, movement at the end portion of the ply piece 56 can be restricted more effectively and stress concentration can be alleviated. A diameter of the tire is slightly increased when an internal pressure is filled. When the overlapping amount K1 is too small at that time, there is a danger that holding of the ply piece 56 by the first belt 26 is released and both members are separated, which may make the internal pressure of the tire difficult to maintain. Furthermore, the sidewalls 14 may be deformed or excessive tension may be applied to the carcass ply 20 due to external force at the time of tire running (for example, at the time of cornering, running on a curb, scratching, and the like) when the overlapping amount K1 is too small. In such case, the end portion of the ply piece 56 which easily moves may be released from the first belt 26 and separated, which may decrease lateral rigidity and reduce steering stability. When the overlapping amount K1 is 5 mm or more, the above problems can be solved.

When the overlapping amount K1 is 50 mm or less, the effect of reducing weight of the tire can be increased. More preferably, the one end 56E of the ply piece 56 is arranged close to the inner side of the belt end 22A by setting the overlapping amount K1 to 15 mm or less, which can further increase the weight reduction effect.

Here, the overlapping amount K1 of the ply piece 56 and the first belt 26 is an overlapping width between the ply piece 56 and the first belt 26 overlapping on the outer side in the tire radial direction RD, of the ply piece 56, which is a length along the ply piece 56. The length along the ply piece 56 means a length along the ply piece 56 from an intersecting point between the straight line L2 passing through the outer end 22A in the width direction of the belt 22 and the ply piece 56 to the one end 56E. It is preferable, for example, that a rubber pad (not shown) is provided between the end portion of the belt 22 and the carcass ply 20, and that the ply piece 56 and the first belt 26 may overlap each other through the pad. Also in this case, the overlapping amount K1 can be calculated from the intersecting point between the straight line L2 and the ply piece 56 by drawing the straight line L2 passing through the outer end 22A in the width direction of the belt 22 in the same manner as above.

In the embodiment, a protruding amount K2 of the first belt 26 from an outer end 28A in the width direction of the second belt 28 is preferably 4 mm or more. The protruding amount K2 is preferably 4 mm or more and 20 mm or less, and more preferably 5 mm or more and 15 mm or less.

When the protruding amount K2 is 4 mm or more, it is possible to avoid concentration of local distortion occurring by the proximity of the outer end 22A in the width direction of the first belt 26 and the outer end 28A in the width direction of the second belt 28. Accordingly, separation of the first belt 26 and the second belt 28 can be suppressed.

Here, the protruding amount K2 of the first belt 26 is a length along the first belt 26 extending on the outer side in the tire width direction WD than the outer end 28A in the width direction of the second belt 28, which is referred to also as an extended amount.

In the embodiment, an overlapping amount K3 between each ply piece 56 of the second ply 56 and the second belt 28 is preferably 3 mm or more. The overlapping amount K3 is preferably 3 mm or more and 45 mm or less, and more preferably, 3 mm or more and 10 mm or less.

When the overlapping amount K3 is 3 mm or more, it is possible to avoid concentration of local distortion occurring by the proximity of the end portion of the ply piece 56 and the end portion of the second belt 28. It is also possible to avoid the end portion of the ply piece 56 from being released and separated from the belt 22. The weight reduction effect of the tire can be increased when the overlapping amount K3 is 45 mm or less.

Here, the overlapping mount K3 between the ply piece 56 and the second belt 28 is an overlapping width between the ply piece 56 and the second belt 28 overlapping on the outer side in the tire radial direction RD of the ply piece 56 at least through the first belt 26, which is a length along the ply piece 56. More specifically, the overlapping amount K3 is a length along the ply piece 56 from an intersecting point between a straight line L3 and the ply piece 56 to the one end 56E. The straight line L3 is a line passing through the outer end 28A in the width direction of the second belt 28 as well as parallel to the tire radial direction RD.

The end portion of the belt 22 is provided so as to directly overlap with the outer circumferential surface of the carcass ply 20 in the shown example; however, it is also preferable that a rubber pad is provided between the end portion of the belt 22 and the carcass ply 20. In this case, an overlapping amount between the pad and the ply piece 56 of the second ply 52 is preferably 5 mm or more as a length along the ply piece 56. When the overlapping amount is 5 mm or more, it is possible to avoid concentration of local distortion occurring by the proximity of the end portion of the ply piece 56 and the end portion of the pad, and possible to suppress separation of the two.

In the embodiment, groove widths of the main grooves, dimensions of the overlapping amounts K1, K3, the protruding amount K2, and the like are values measured in an unfilled state in which the pneumatic tire is fitted to a normal rim and the internal pressure is not filled. The normal rim is a rim prescribed by each tire in a standard system including standards with which the tire complies, which is, for example, a “standard rim” in JATMA, “Design Rim” in TRA, and “Measuring Rim” in ETRTO.

### EXAMPLES

Pneumatic radial tires for passenger cars (tire size: 235/55R20 102W) according to Examples 1 to 3 were manufactured as prototypes with the structure shown in FIG. 1 to FIG. 3 in accordance with specifications shown in the following Table 1. As Comparative Example 1, a radial tire having the same structures as those in Embodiment 1 except that the second ply 52 of the carcass ply 20 does not have the structure with the pair of ply pieces 56, 56 but has the same normal ply structure as the first ply 50 was manufactured as a prototype. As Comparative Example 2, a radial tire having the same structures as those in Embodiment 1 except that the one end 56E of the ply piece 56 in the second ply 52 is placed on the inner side in the tire width direction WD of the shoulder main groove 40 was manufactured as a prototype.

Concerning tires according to Examples 1 to 3, and Comparative Examples 1, 2, tire mass, riding comfort, and durability were evaluated. An evaluation method is as follows:

Riding comfort (enveloping characteristics): A prototype of the tire fitted to the normal rim (20×7.5) and mounted to a passenger car was set to a vehicle-designated air pressure, and sensory evaluation of riding comfort was relatively conducted on a dry uneven road by a professional driver from viewpoints of the impact, vibration and the like. Results are shown by index numbers in which evaluation of Comparative Example 1 is set to 100. The larger the index number is, the more excellent the riding comfort is.

Durability: A durability test was conducted by a method prescribed by FMVSS139. The speed and load were continuously applied to the tire when damage or the like was not confirmed after a test stage 3 was finished, and a test time until a defect was confirmed was measured. Results are shown by index numbers in which evaluation of Comparative Example 1 is set to 100. The larger the index number is, the more excellent the durability is.

TABLE 1

| | | | | Comparative | Comparative |
|---|---|---|---|---|---|
| | Example 1 | Example 2 | Example 3 | Example 1 | Example 2 |
| Specifications | | | | | |
| Position of | Outer side of | Outer side of | Outer side of | Second ply has | Inner side of |
| one end 56E of | shoulder main | shoulder main | shoulder main | same structure | shoulder main |
| second ply 52 | groove 40 and | groove 40 and | groove 40 and | as first ply | groove 40 |
| | inner side of | inner side of | inner side of | | |
| | outer end 22A in | outer end 22A in | outer end 22A in | | |
| | width direction | width direction | width direction | | |
| | of belt | of belt | of belt | | |
| Overlapping | 9 | 15 | 5 | | 50 |
| amount K1 (mm) | | | | | |
| Protruding | 6 | 6 | 4 | | 6 |
| amount K2 (mm) | | | | | |
| Overlapping | 3 | 9 | 1 | | 44 |
| amount K3 (mm) | | | | | |
| Evaluation | | | | | |
| (index number) | | | | | |
| Tire mass | 107 | 105 | 110 | 100 | 102 |
| Riding comfort | 110 | 108 | 110 | 100 | 103 |
| Durability | 100 | 100 | 95 | 100 | 100 |

Results are shown in Table 1. In Examples 1 to 3, the one end 56E of the ply pieces 56 in the second ply 52 is positioned on the outer side in the tire width direction WD of the shoulder main groove 40 and on the inner side of the outer end 22A in the width direction of the belt 22. In Examples 1 to 3, the tire was reduced in weight and riding comfort was improved with excellent enveloping characteristics as compared with Comparative Example 1 having the so-called two-ply structure. Also in Examples 1 to 3, reduction in weight of the tire and riding comfort were excellent as compared with Comparative Example 2 in which the one end 56E of the ply piece 56 is positioned on the inner side in the tire width direction WD of the shoulder main groove 40.

Some embodiments of the present invention have been explained above. These embodiments have been cited as examples and do not intend to limit the scope of the invention. These embodiments can be achieved in other various manners and can be omitted, replaced or altered in various manners within a scope not departing from the gist of the invention. These embodiments and modifications thereof are included in the scope and the gist of the invention as well as included in inventions described in claims and the scope of equivalency thereof.

What is claimed is:

1. A pneumatic tire comprising:
a pair of bead cores;
a carcass ply containing organic fiber cords;
a belt; and
a tread rubber provided on an outer side in a tire radial direction of the belt,
wherein the tread rubber is provided with a pair of shoulder main grooves extending in a tire circumferential direction so as to demarcate shoulder lands from a land on an inner side thereof in a tire width direction,
the carcass ply includes a first ply hung between the pair of bead cores and a second ply comprising a pair of ply pieces arranged on tire outer surface sides of the first ply and respectively extending from one ends positioned in a tread to beads on both sides through sidewalls on both sides to be folded around the bead cores, and
each of the one ends of the pair of ply pieces of the second ply is positioned on an outer side in the tire width direction than the shoulder main groove and on the inner side in the tire width direction than an outer end in a width direction of the belt.

2. The pneumatic tire according to claim 1,
wherein the belt includes a first belt having the maximum width and a second belt arranged on the outer side in the tire radial direction of the first belt, and
an overlapping amount of each of the pair of ply pieces and the first belt is 5 mm or more.

3. The pneumatic tire according to claim 2,
wherein the overlapping amount of each of the pair of ply pieces and the first belt is 5 mm or more and 50 mm or less.

4. The pneumatic tire according to claim 1,
wherein the belt includes a first belt having the maximum width and a second belt arranged on the outer side in the tire radial direction of the first belt, and
a protruding amount of the first belt from an outer end in the width direction of the second belt is 4 mm or more.

5. The pneumatic tire according to claim 2,
wherein a protruding amount of the first belt from an outer end in the width direction of the second belt is 4 mm or more.

6. The pneumatic tire according to claim 1,
wherein the belt includes a first belt having the maximum width and a second belt arranged on the outer side in the tire radial direction of the first belt, and
an overlapping amount of each of the pair of ply pieces and the second belt is 3 mm or more.

7. The pneumatic tire according to claim 2,
wherein an overlapping amount of each of the pair of ply pieces and the second belt is 3 mm or more.

8. The pneumatic tire according to claim 4,
wherein an overlapping amount of each of the pair of ply pieces and the second belt is 3 mm or more.

9. The pneumatic tire according to claim 5,
wherein an overlapping amount of each of the pair of ply pieces and the second belt is 3 mm or more.

10. The pneumatic tire according to claim 1,
wherein the first ply includes a first ply body extending between the pair of bead cores and a pair of first folded portions extending from the first ply body and folded from the inner side to the outer side in the tire width direction around the pair of bead cores, and
the pair of first folded portions extend to the outer side in the tire radial direction through outer sides in the tire width direction of bead fillers and terminate on the inner side in the tire radial direction than the outer ends in the width direction of the belt.

11. The pneumatic tire according to claim 1,
wherein each of the pair of ply pieces of the second ply includes a second ply body extending from the one end to the bead core and a second folded portion extending from the second ply body and folded from the inner side to the outer side in the tire width direction around the bead core, and
an outer end in the tire radial direction of the second folded portion is positioned between an outer circumferential surface of the bead core and an outer end in the tire radial direction of the bead filler.
